(19) United States
(12) Patent Application Publication
(10) Pub. No.: US 2019/0012699 A1
(43) Pub. Date: Jan. 10, 2019

(54) SYSTEMS AND METHODS FOR FIRST PARTY MOBILE ATTRIBUTION

(71) Applicant: FRECKLE IOT, LTD., TORONTO (CA)

(72) Inventor: NEIL SWEENEY, TORONTO (CA)

(21) Appl. No.: 15/641,488

(22) Filed: Jul. 5, 2017

(51) Int. Cl. G06Q 30/02; H04W 4/02; H04W 76/02; H04W 40/24

(52) U.S. Cl. CPC G06Q 30/0246; G06Q 30/0267; H04W 40/244; H04W 76/02; H04W 4/023

(57) ABSTRACT

A method, systems and computer program product for first party mobile attribution are described. Impression data, mobile device locations, beacon data/information and other data points are collected and converted by an Analytics Server to determine the effectiveness of a marketing or advertising campaign and how the campaign influenced a visit to a store and subsequent purchase as a result of the campaign.

### FIELD OF THE INVENTION

The present disclosure relates generally to methods, computer program product and systems of first party mobile data attribution. Specifically, the disclosure relates to methods, computer program product and systems geared towards measuring the offline conversion of a customer exposed to a digital advertisement of a digital marketing campaign thereby highlighting the campaign's effectiveness.

### BACKGROUND OF THE INVENTION

Brands leverage the scale of digital advertisements to drive customers to their brick-and-mortar store locations. Previously, the ability to measure the effectiveness of running a digital marketing campaign did not exist. Currently, the industry standard for attempting to do so makes use of click-through-rates (CTR) in determining the effectiveness of an advertisement or a digital marketing campaign. However, the CTR model is a highly unreliable metric. As such, there exists a need for a process or method for effective attribution that measures an offline conversion of a customer exposed to a digital advertisement or a digital marketing campaign. In other words, there exists a need to identify the effectiveness of a particular digital marketing campaign in driving a customer to a store.

### SUMMARY OF THE INVENTION

Aspects of embodiments of the present invention contemplate the collection of customer data from a number of sources and converting the collected data into one or more attribution measures or data points. This may include the use a software development kit (SDK) on a mobile device to collect first party data and anonymously monitor the movement of customers that visit various retail locations. The collected/generated data may be overlaid against other data (e.g. impression data, purchase data, etc.) using applied systems, methods and code. This helps in solving the offline attribution problem by effectively identifying the effectiveness of a particular digital marketing campaign in driving a customer to a store. Similar to the way a website is able to measure successful “conversions” through the use of tracking tags that pull cookie data from advertisement impressions to online store visits, the offline attribution solution measures the effectiveness of mobile display advertisements in the actual, physical world, effectively creating a walk-through rate. Aspects of embodiments of the contemplated invention in distinguishing itself from other applications, uses first party data collected using the SDK to provide insights and make inferences regarding consumer behavior. This presents a unique situation where collected data enables customers to know how effective campaigns were at driving traffic to their store. In addition, aspects of embodiments of the present invention provide offline attribution technology which uses location and other non-personally identifiable data from devices to determine, on an aggregate basis, how many users were present or seen at a certain location. As a customer or user's device moves around a physical environment, the SDK resident on it makes requests for regions to monitor within the mobile device's area. These regions are registered in the mobile device's memory. Once a region is entered, the “Enter” event is pushed or sent to a server which records the entry. Similarly, upon leaving a region, an “Exit” is sent to the same server for recordation. In addition to this information, the mobile device may also send the time, its identification number, latitude, longitude, horizontal accuracy, Service Set Identifier (SSID) and region identification to the server. These regions may be physical beacon regions or virtual beacon regions (or geofence region).

Aspects of embodiments of the present invention contemplate providing a solution where the data collected is first party data and where the data is collected and/or compiled in real time. The first party data is collected through the SDK and its interaction with beacons as well as a Visit Application Programming Interface (API). As a result, the data is high fidelity i.e more accurate with more data points.

Similar to the way an online website can measure the effectiveness of media in driving customers to their online store, aspects of embodiments of the present invention measure the same effectiveness to physical stores in the real world.

### BRIEF DESCRIPTION OF THE DRAWINGS

FIG. 1 illustrates a system for the delivery and collection of data relating to an advertisement delivered to a mobile device according to an aspect of an embodiment of the present invention.

FIG. 2 illustrates a process of delivery and collection of data relating to an advertisement delivered to a mobile device according to an aspect of an embodiment of the present invention.

FIG. 3 illustrates a system showing system components for collection of a mobile device's location data using a physical beacon according to an aspect of an embodiment of the present invention.

FIG. 4 illustrates a process for the collection of a mobile device's location data using a physical beacon according to an aspect of an embodiment of the present invention.

FIG. 5 illustrates a system showing system components for collection of a mobile device's location data using a virtual beacon according to an aspect of an embodiment of the present invention.

FIG. 6 illustrates a process for the collection of a mobile device's location data using a virtual beacon according to an aspect of an embodiment of the present invention.

FIG. 7 illustrates a system showing system components for collection of purchase data according to an aspect of an embodiment of the present invention.

FIG. 8 illustrates a process for the collection of purchase data according to an aspect of an embodiment of the present invention.

FIG. 9 illustrates an analysis process by an analytics server according to an aspect of an embodiment of the present invention.

### DETAILED DESCRIPTION OF THE INVENTION

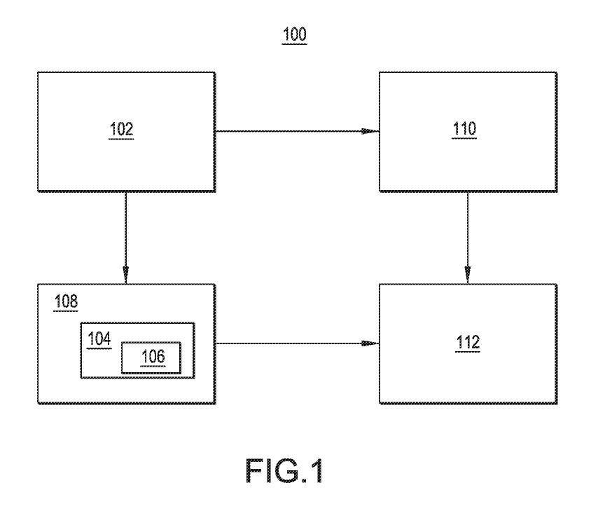

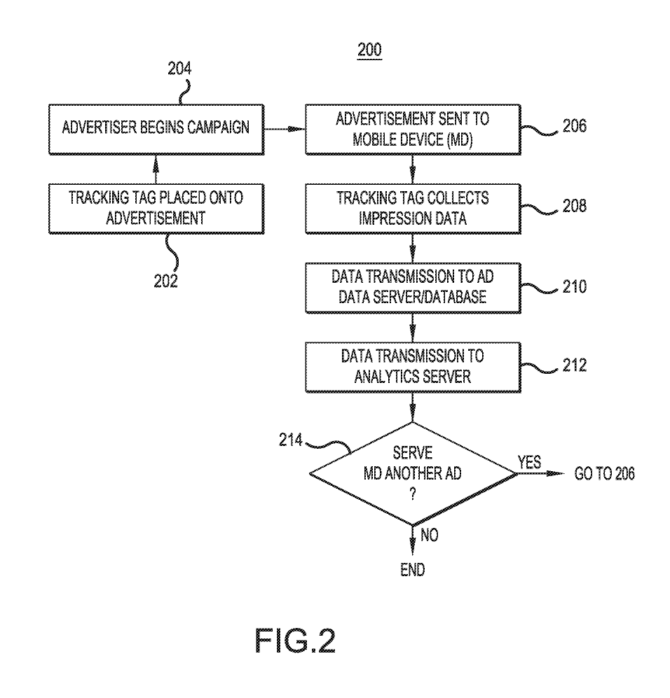

Referring now to FIGS. 1 and 2, a system 100 and a process 200 for the delivery and collection of advertisement data related to an advertisement 104 delivered to a mobile device 108 are both shown according to aspects of embodiments of the present invention. Advertisement data collection process 200 begins at step 202 with having a tag 106 embedded into a digital advertisement 104. In an aspect of an embodiment of the present invention tag 106 may be an image pixel that is used to track the impression data of advertisement 104 in that the image pixel keeps a record of the devices to which advertisements were delivered. In one aspect, this may be a 1×1 image pixel. The image pixel may be software code that is coded to track the impression data of advertisement 104. As used in this disclosure, when an advertisement is delivered to mobile device 108, this constitutes an “impression”. When an image pixel is inserted into an ad advertisement, a user is served with a transparent 1×1 pixel.

Following the embedding of tag 106 onto digital advertisement 104, the advertiser begins the marketing campaign in step 204 and then sends advertisement 104 from Ad Server 102 to mobile device 108 in step 206. Implementation of the marketing campaign may, in an aspect of an embodiment of the present invention, be implemented using a data service provider (DSP) which serves or delivers advertisement 104 to mobile device 108. In another aspect of an embodiment of the present invention, the DSP may keep a log of the mobile devices to which advertisement 104 was sent. The DSP may also keep a log of mobile devices that were not served with advertisement 104. In an aspect of an embodiment of the present invention, the DSP may send any one or more of these logs to Analytics Server 112 for certain attribution calculations. In another aspect, the DSP may send any one or more of the logs to mobile device 108.

Upon transmission of advertisement 104 to mobile device 108, mobile device 108 is served with a transparent 1×1 pixel or tag 106 in step 208. Upon rendering advertisement 104 on mobile device 108, an “impression” is recorded. Then mobile device 108 collects the impression data associated with advertisement 104 and transmits, in step 210, the same to Ad Data Server 110. This data may include, without limitation, the advertiser's identification, location, time, campaign identification, Attribution ID, IP Address, User Agent, IDFA (Identifier for advertisers) (if available from the DSP), Advertising ID (if available from the DSP) and other meta-data about mobile device 108 rendering the image pixel. In another aspect of an embodiment of the present invention, the DSP may maintain a real-time log of delivered impressions. Ad Data Server 110 streams in real-time data from ad serving impressions. DSP may also transmit its log of mobile devices which were served with advertisement 104.

Next, in step 212, the collected data may be sent from Ad Data Server 110 to Analytics Server 112 which performs the attribution calculations, collected data conversions etc. In one aspect, the transmission may be governed by certain campaign parameters entered or followed by Analytics Server 112 to determine when to require the data to be transmitted to Analytics Server 112. In one aspect of an embodiment of the present invention, Ad Data Server 110 may be agnostic in its data collection as it may be enabled to collect impression data from different advertising platforms and/or data sources.

In an aspect of an embodiment of the present invention Ad Data Server 110 may be connected or linked with a database which serves as a repository for data received by Ad Data Server 110. The database may also be in connection with Analytics Server 112 which can call on it to retrieve data for attribution calculations. In another aspect, Ad Data Server 110 may call on the database to retrieve stored data in order to transmit the same to Analytics Server 112.

Returning now to process 200, the DSP, in step 214, then makes a determination as to whether to serve mobile device 108 with another advertisement. This determination may be based on previously defined parameters governing the frequency, type and timing of advertisements being sent to mobile device 108. If the determination at decisional step 214 is to serve mobile device 108 with another advertisement, then the process proceeds to step 206 where another advertisement is served to mobile device 108. If the determination at decisional step 214 is negative, the process ends.

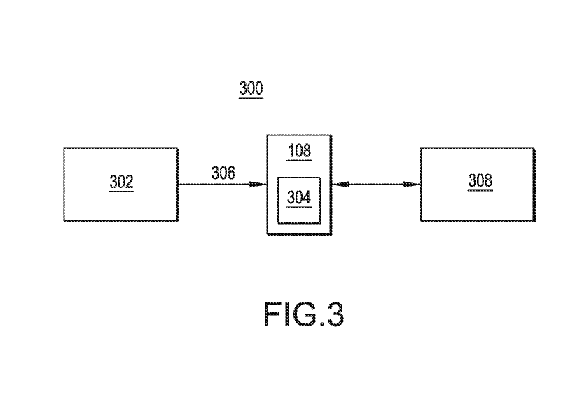

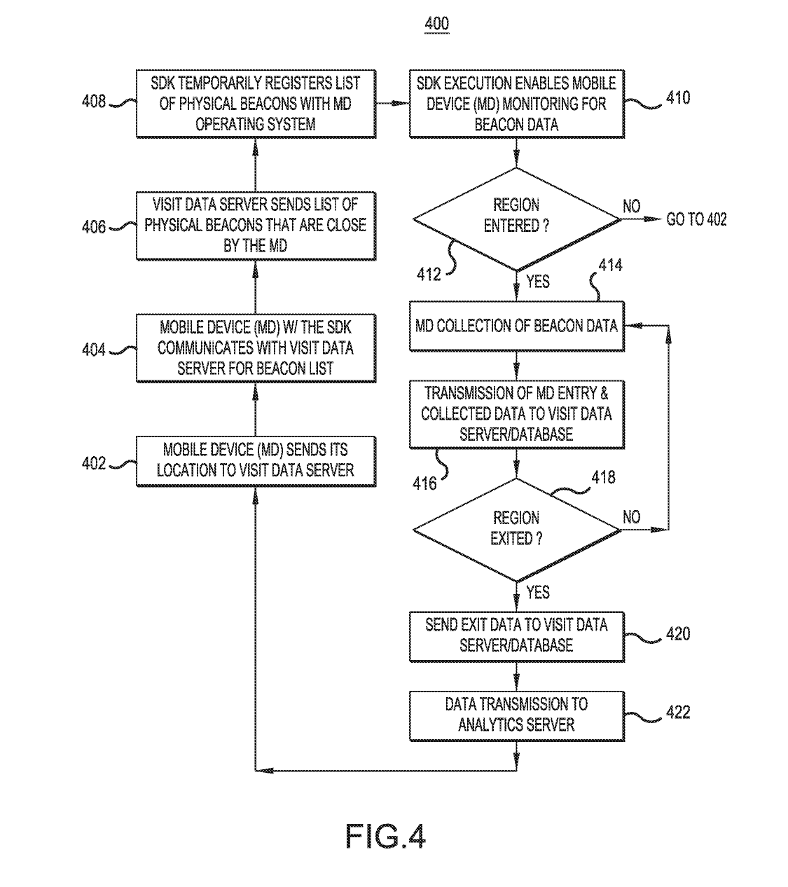

Referring now to FIGS. 3 and 4, a system 300 and a process 400 illustrating the collection of mobile device 108's location data using a physical beacon 302 are shown according to aspects of embodiments of the present invention. The data collection begins with step 402 where mobile device 108 provides Visit Data Server 308 with the mobile device 108's location. IN an aspect of an embodiment of the present invention, Visit Data Server 308 may be a collection of different servers performing multiple functions. In another aspect, Visit Data Server 308 may be one server performing different functions.

Mobile device 108, in one aspect of an embodiment of the present invention, may have a software development kit (SDK) 304 installed on it. Execution of SDK 304 enables mobile device, in step 404, to communicate with Visit Data Server 308 to request the list of beacons close to mobile device 108's location. The SDK also enables communication and connection between mobile device 108 and Visit Data Server 308.

Upon receipt of the request, Visit Data Server 308 in step 406 provides mobile device 108 with the list of beacons that are in close proximity to mobile device 108's location. Further execution of SDK 304 enables temporary registration or storing of the received list, in step 408, within the operating system/memory of mobile device 108. In one aspect of an embodiment of the present invention, this is a temporary action as mobile device 108 may be allowed to store a limited number of data and would rely on Visit Data Server 308 for the provision of new beacon lists. In an aspect of an embodiment of the present invention, because of memory restrictions on mobile device 108, mobile device 108 may be allowed by its operating system to hold a certain number of beacon information in its memory. As such, mobile device 108 may request a fresh list each time it changes its location—thereby saving memory space.

Referring back to process 400, mobile device 108 in step 410 monitors for beacons within its area leading to decisional step 412 where it determines whether it has entered a beacon region. In one aspect of an embodiment of the present invention, this determination may include the step of determining whether a beacon threshold has been reached—meaning whether mobile device 108 has traveled close enough to beacon 302 or whether mobile device 108 has taken too long to enter the region of beacon 302. In situations where mobile device 108 has not yet entered the region for beacon 302, the process reverts to step 402. If mobile device 108 enters beacon 302's region, the process moves to step 414 where mobile device 108 collects beacon 302's data 306. In one aspect of an embodiment of the present invention, data 306 may include major and minor values, beacon 302's identification number, beacon 302's location etc. In an aspect of an embodiment of the present invention, beacon 302 may use low energy Bluetooth to transmit its information to mobile device 108.

Once beacon 302's data is collected, mobile device 108, in step 416, transmits the collected data to Visit Data Server 308. The process then proceeds to decisional step 418 to determine whether mobile device 108 has exited beacon 302's region. If the determination at decisional step 418 is that mobile device 108 has exited the region, the exit data is sent to Visit Data Server 308 in step 420. If mobile device 108 has not yet exited from beacon 302's region, the process proceeds to step 414, where mobile device 108 continues to collect data from beacon 302.

Following the process from step 420, Visit Data Server 308 stores the data collected by mobile device 108 until prompted for its transmission, in step 422 to Analytics Server 112. Following this transmission, the process reverts back to step 402 upon mobile device 108's exit from beacon 302's region to enable mobile device 108 to update Visit Data Server 308 of its new location so a new beacon list, if warranted, may be sent to mobile device 108 and the process continues.

A certain aspect of an embodiment of the present invention contemplates making impression determinations using location data of mobile device 108 and an out of home advertising such as a physical billboard. In this aspect, beacon 302 may be placed at or around the physical billboard displaying the campaign advertisement. Next, when mobile device 108 comes close to the physical billboard, it collects beacon 302's data such as its identification, location etc. This data is then sent to Visit Data Server 308 to determine and record mobile device 108's location and proximity to beacon 302. Mobile device 108's proximity to beacon 302 would indicate the presence of the physical advertisement or billboard at the location. In addition, data from mobile device 108's accelerometer, compass, directional path, speed etc. would be stored and transmitted to Visit Data Server 308 to help determine whether the customer was facing the advertisement (and hence saw it). Mobile device 108's speed would also be stored and transmitted to Visit Data Server 308 to determine whether the customer was walking, in a car etc. In another aspect of an embodiment of the present invention, mobile device 108 may also transmit its coordinates once beacon 302 (located at or near the billboard) has been detected. In another aspect, Visit Data Server 308 may send mobile device 108 the coordinate list for beacons which mobile device 108 would monitor using its GPS. In yet another aspect, beacon 302 may be set to monitor its coordinates for entry of a mobile device having an SDK. Once detected, beacon 302 would relay the data relating to the detected mobile device to Visit Data Server 308.

The SDK on mobile device 108 sorts the beacon list received from Visit Data Server 308 in order to enable Analytics Server 112 caton determine, for instance, which mobile device was at a particular area and presumably saw the physical billboard and subsequently went to the store associated with the advertisement on the billboard. The SDK also, upon receipt of beacon 302's data, categorizes the location data by beacon 302's identification.

In an aspect of an embodiment of the present invention Visit Data Server 308 may be linked with a database which serves as a repository for data received by Visit Data Server 308. The database may also be in communication or connection with Analytics Server 112 which can call on it to retrieve data for attribution calculations. In another aspect, Visit Data Server 308 may call on the database to retrieve stored data in order to transmit the same to Analytics Server 112.

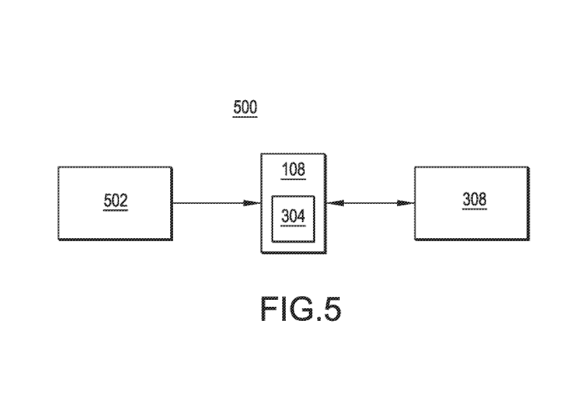

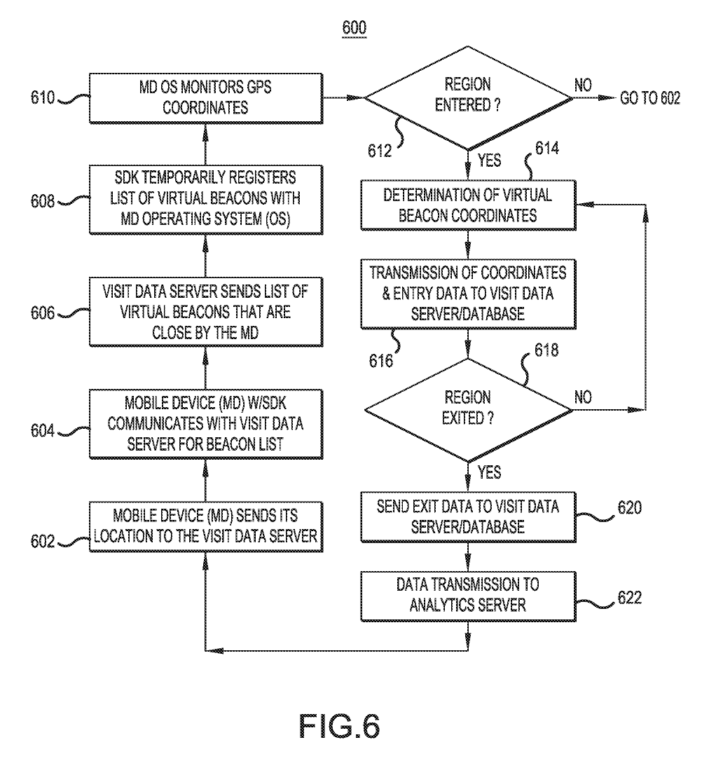

Referring now to FIGS. 5 and 6, a system 500 and a process 600 illustrating the collection of mobile device 108's location data using a virtual beacon 502 are shown according to aspects of embodiments of the present invention. Virtual beacon 502, may, in one aspect of an embodiment of the present invention, be a modified geofence which may constitute specific or optimized code used in conjunction with a standard geofence to enable the geofence to behave more accurately in smaller radii geofences as opposed to situations where they would typically operate with geofences having radii larger than 100-200 meters. This also allows for the list of locations to be refreshed on mobile device 108 rather than storing a set number of geofences.

The data collection, in process 600, begins with step 602 where mobile device 108 provides Visit Data Server 308 with the mobile device 108's location. Mobile device 108, in one aspect of an embodiment of the present invention, may have software development kit (SDK) 304 installed on it. Execution of SDK 304 enables mobile device in step 604 to communicate with Visit Data Server 308 to request the list of beacons close to mobile device 108's location. Upon receipt of the request, Visit Data Server 308 in step 606 provides mobile device 108 with the list of virtual beacons that are in close proximity to mobile device 108's location. Also sent to mobile device 108, in another aspect, are the latitude and longitude coordinates of each virtual beacon. Further execution of SDK 304 enables registration or storing of the received list, in step 608, within the operating system/memory of mobile device 108. In one aspect of an embodiment of the present invention, this is a temporary action in that mobile device 108 may be allowed to store a limited number of data and would rely on Visit Data Server 308 for the provision of beacon lists. Next, in step 610, mobile device 108 monitors its global positioning system (GPS) coordinates to determine whether it has entered a virtual beacon's region thereby leading to decisional step 612 where it determines whether it has entered a beacon region, which, in this case, are particular coordinates defining a certain geofence. In an aspect of an embodiment of the present invention, the determination as to whether mobile device 108 has entered a virtual beacon's region may be implemented by having mobile device 108 match or compare its GPS coordinates against the latitude and longitude coordinates of the virtual beacons as previously sent to it by Visit Data Server 308.

In situations where mobile device 108 has not yet entered the region for beacon 502, the process reverts to step 602. If mobile device 108 enters beacon 502's region, mobile device 108, in step 614, confirms the coordinates of beacon 502 by referring back to its beacon list and comparing it with its GPS coordinates. Mobile device 108 then, in step 616 transmits beacon 502's coordinates (along with its coordinates, in one aspect) to Visit Data Server 308. The process then proceeds to decisional step 616 to determine whether mobile device 108 has exited beacon 502's region (i.e. moved away from the coordinates). If mobile device 108 exits the region, the exit data is sent to Visit Data Server 308 in step 618. If mobile device 108 has not yet exited from beacon 502's region (i.e. where mobile device 108's coordinates are the same as the coordinates of virtual beacon 502), the process proceeds to step 614. Visit Data Server 308 stores the data collected by mobile device 108 until prompted for its transmission, in step 620 to Analytics Server 112. Following this transmission, the process reverts back to step 602 upon mobile device 108's exit from beacon 502's region to enable mobile device 108 to update Visit Data Server 308 of its new location so a new beacon list, if warranted, may be sent to mobile device 108 and the process starts over. With process 600 starting over, the beacon list and data sent to mobile device 108 is thus refreshed as mobile device 108 enters and exits every relevant (i.e. virtual beacon 502) geofence.

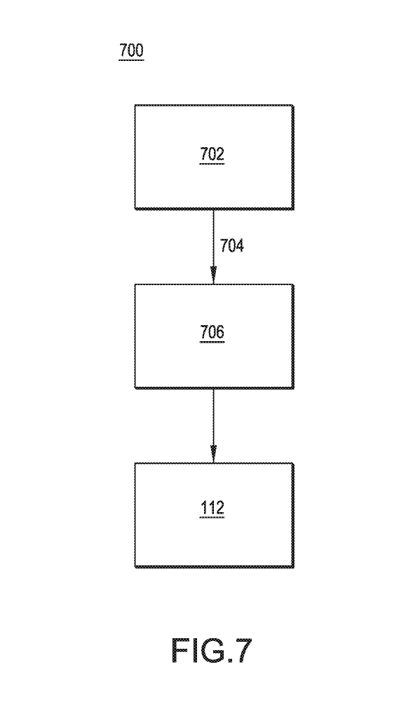

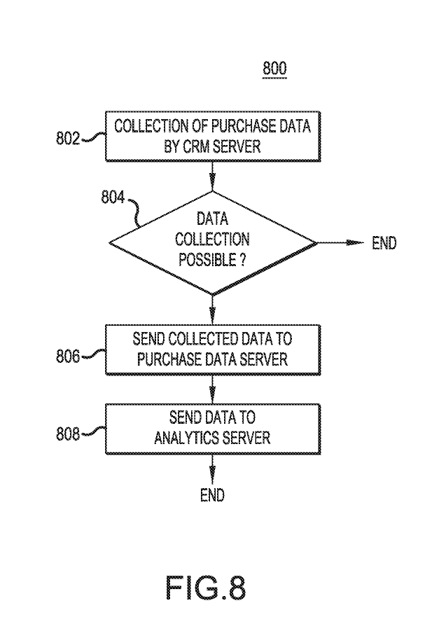

Referring now to FIGS. 7 and 8, a system 700 and process 800 for collection of purchase data are both shown according to aspects of embodiments of the present invention. Process 800 begins at step 802 with the collection of a customer purchase information using a third-party Customer Relationship Management Computer 702. Information collected may include receipt amount, product SKU, purchase date, product information, location of the purchase and potentially the mobile device's identification number. Following collection of the purchase information, the purchase process proceeds to decisional step 804 to determine whether the data collection and transmission is possible. In an aspect of an embodiment of the present invention, the data collection and transmission may be made possible if the customer's mobile device is able to convey its presence at the location of the purchase and if it may be used in the purchase. If the data collection and transmission is not possible, the process ends. If, however, it is, the process proceeds to step 806 where the collected purchase information is transmitted via the internet (704) to Purchase Data Server 706 which holds the purchase information until prompted to send the information, in step 808 to Analytics Server 112. In certain aspects, data sources for purchase data may include retailers, credit card companies, banks, third party aggregators, mobile applications with photo receipt capture etc. In an aspect of an embodiment of the present invention, purchase data may be collected by a third-party server or entity. The data collected may include the percentage of people that went into a particular store, what percentage of that group made a purchase, and what was the cost of an average purchase. This collected data may be called upon by Analytics Server 112 which may then query the third-party server regarding certain mobile device identification numbers (that Analytics Server 112 already has in the system), knowing that these mobile devices (108) are those within system 100. The data may also be collected where mobile device 108 has a payment application on it and the purchase data is now registered or recorded and sent to Analytics Server 112. In another aspect of an embodiment of the present invention, the data may be collected using a website where a profile of the customer and the customer's mobile device is created and recorded and the customer's purchases are also recorded and subsequently sent to Analytics Server 112.

In an aspect of an embodiment of the present invention Purchase Data Server 706 may be linked with a database which serves as a repository for data received by Purchase Data Server 706. The database may also be in connection with analytics server 112 which can call on it to retrieve data for attribution calculations. In another aspect, Purchase Data Server 706 may call on the database to retrieve stored data in order to transmit the same to the analytics server 112.

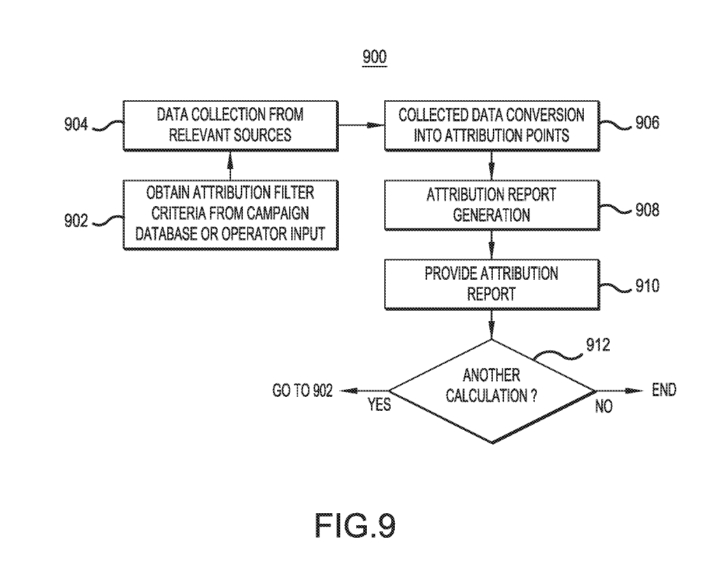

Referring now to FIG. 9, an analysis process 900 by Analytics Server 112 is shown according to an aspect of an embodiment of the present invention. Analytics Server 112, may in one aspect, be a cluster of servers used to receive, analyze and convert collected data into attribution data points. In another aspect, Analytics Server 112 may be one server.

Analysis process 900 begins with Analytics Server 112 obtaining filter criteria from a Campaign Database 901 (not shown). The filter criteria may include previously stored or set information for determining certain aspects of a marketing campaign which may include, but not be limited to: date of campaign, location of purchases, type of campaign etc. It should be noted that the mobile device location data, advertising impression data and purchase data are all collected independently from one another with no dependencies. In an aspect of an embodiment of the present invention, Analytics Server 112 may also receive the filter criteria directly from an operator via direct input—in which the operator may provide the filter criteria directly to Analytics Server 112. Once the campaign filter criteria have been obtained in step 902, the process proceeds to step 904 where Analytics Server 112 obtains data from the relevant sources based on the filter criteria. For instance, if the filter criteria required impression data and mobile device location data, Analytics Server 112 would collect the information from Ad Data Server 110 and Visit Data Server 308. Upon receipt of the relevant data, Analytics Server 112 then proceeds, in step 906, to perform attribution calculation for the marketing campaign. In one aspect of an embodiment of the present invention, data collected from the Visit Data Server 308, Ad Data Server 110 and Purchase Data Server 706 may be layered upon each other by Analytics Server 112 in converting the collected data into an attribution data point. In which case, the attribution conversion process would require that customer or user of mobile device 108 would have been served at least one advertisement, he/she would have been seen (or located) at a store and purchased the product advertised at least once. In another aspect of an embodiment of the present invention, Analytics Server 112 may also receive data from different sources other than mobile device 108. For instance, purchase and customer data as collected by a store or other entity, may be sent to Analytics Server 112 to make an attribution calculation. These other sources may include, servers, APIs, etc.

In an aspect of an embodiment of the present invention, Analytics Server 112 may calculate the base attribution rate, where the base attribution rate is the percentage of users of mobile devices 108 that were served digital advertisement 104 and were determined to have been located at an advertised location (or in close proximity to a physical advertisement, such as a billboard). In another aspect of an embodiment of the present invention, Analytics Server 112 may also calculate “lift” by determining the difference in visitation rate of users (or owners of mobile devices 108) exposed to digital advertisement 104 and users who were not exposed to digital advertisement 104.

Following the attribution calculation in step 906, Analytics Server 112 generates and produces an attribution report in steps 908 and 910 respectively. The report may be sent to the client at the end of a campaign or it may be delivered in real-time. Next, Analytics Server 112 in decisional step 912 determines whether another calculation is to be performed. If one is to be performed, the analysis process proceeds to step 902. If none is required, analysis process 900 ends.

In another aspect, Analytics Server 112 in its data conversion may match the timestamp, device identification, location data from both the impression data and location of mobile device 108 to provide an attribution data point to determine a successful attribution. In this case, the customer using mobile device 108 would have been served an advertisement and then seen at a store location at least once. This data conversion and attribution tells advertisers how effective the advertisement was at driving traffic to their store.

Analytics Server 112 may also provide a lift data point by comparing visitation rates between customers that were exposed to advertisement 104 and those who were not.

To determine whether a media campaign was successful, aspects of embodiments of the present invention use an exposed group-control study. An exposed group control-study can provide a lift metric that represents a media's effectiveness at driving customers. Using both the impression and beacon data collected on a campaign and control study generated with each report. The high-level concept of the control study is to use the collected data to divide users or customers, within the geographical region of the campaign into two groups—exposed and unexposed. From these two groups, an average visitation rate for the time period of the campaign is calculated and compared by Analytics Server 112. In the positive scenario, there is a lift generated within the exposed group. In the negative scenario, there is a zero or negative lift generated within the exposed group. In an aspect of an embodiment of the present invention, Lift is given by the exposed average visitation rate divided by the unexposed average visitation rate.

Analytics Server 112 may also, in other aspects of embodiments of the present invention, engage in a number of conversion operations or determinations such as:

Audience served an impression—which is the unique count of customers that were served an impression.

In-store attribution rate—which is the percentage of users served an impression and then seen in-store (e.g. had their mobile device 108 detected in the location). In one aspect of an embodiment of the present invention, duplicate conversions are counted. In another aspect where the in-store attribution is de-duplicated, only one successful conversion per customer is counted.

Conversion volume—which is the audience served an impression multiplied by the in-store attribution rate.

Lift—which is (as discussed above) the control study lift from exposure to the campaign or creative.

ROAS—i.e. Return On Ad Spend—which is the return on investment for the campaign. This requires an average visit value and cost per thousand impressions (CPM) value to calculate. ROAS is given by dividing the product of the average visitation value with the conversion volume by the cost of the campaign. The cost of the campaign may be given by multiplying the CPM with the impressions served and dividing all by 1000.

For ROAS de-duplicated, the calculation is the same as for ROAS except for counting for one conversion per IDFA.

Different servers of the system as contemplated in the present invention are enabled to collect certain data points regarding customer visit behavior. In an aspect of an embodiment of the present invention, this may be undertaken by Analytics Server 112. These include average impressions served before visit, which is the average number of impressions shown before a user visited the location. This metric averages out all successful conversion to derive a value.

Minimum impressions served before visit—this is the minimum average number of impressions shown before a user visited the location. This metric takes the minimum impression count per customer to derive this value (as some customers will have multiple conversions).

In an aspect of an embodiment of the present invention, any one or more of the different servers of system 100 may gather information regarding the time spent along with the frequency of customer visits to stores or locations within a campaign. Among these are:

Average Time Spent In-Store: The average duration of a visit across all of the stores in the campaign.

Minimum Time Spent In-Store: The average minimum duration of a visit across all of the stores in the campaign.

Maximum Time Spent In-Store: The average maximum duration of a visit across all of the stores in the campaign.

Frequency of Visit: The average number of times a customer returns to any or all of the stores.

In an aspect of an embodiment of the present invention, the term “server” may mean a processor or a group of processors. In another aspect of an embodiment of the present invention, “server” may include one or more processors in communication one or more memory or storage devices. In yet another aspect of an embodiment of the present invention, “server” may include a combination of one or more processors with one or more memory or storage devices.

In another aspect of an embodiment of the present invention, system 100 and/or components of system 100 may include software and/or hardware implemented devices (or computer program devices) that implement the present invention. For instance, any one or more of system 100's servers may include application code which the server(s) may execute using an interpreter which, upon receipt of the application code, generates executable instructions that could then be executed by an execution component of one or more of the servers of system 100. These executable instructions may include calls to the operating system of any or more of system 100's components or may manipulate data in memory of any one or more of system 100's components.

In a further aspect of an embodiment of the present invention, steps, processes, operations or methods undertaken by system 100 and/or system 100's components, as discussed above, may be implemented by execution, on one or more servers or processors configured to perform a predefined set of basic operations in response to receiving a corresponding basic instruction selected from a predefined native instruction set of codes. This native instruction set of codes or machine language instruction codes may be built into servers/processors of system 100's components. As such, different operations contemplated by the disclosure above, may be made possible by the selection of machine codes from specific machine language instruction codes. Additional complex operations may be made possible by the combination of different sets of machine language instruction codes.

Further aspects of embodiments of the present invention contemplate the use of non-transitory computer programmable product for the implementation of the different processes outlined above. The same may be found installed on any or all of the components discussed in this application including, without limitation, the mobile device(s), beacons, servers etc.

Other aspects of embodiments of the present invention also contemplate implementation of the different processes and systems described above using a variety of computers, processors or similar devices.

The invention has been described in detail with particular reference to certain preferred embodiments thereof, but it will be understood that variations and modifications can be effected within the spirit and scope of the invention.

What is claimed is:

1. A computer-implemented method of first party data mobile attribution using multiple independent sources of computer derived data, comprising the steps of:
impression monitoring, by a 1×1 pixel tag embedded within at least one digital advertisement served to at least one mobile device;
transmission, by the at least one mobile device, of the 1×1 pixel tag's impression data to an Ad Data Server, wherein the impression data includes any one or more of the following: location of the at least one mobile device, time, campaign identification of the at least one digital advertisement, identification of an entity serving the at least one digital advertisement;
transmission, from the Ad Data Server, of the collected data to an Analytics Server, wherein the collected data is any one or more of: impression data relating to the at least one digital advertisement, impression data from at least one virtual beacon, impression data from at least one physical beacon, purchase data from a purchase data server, location data of the at least one mobile device; and
conversion of the transmitted data by the Analytics Server, wherein the conversion comprises of an attribution calculation.

2. The computer-implemented method of claim 1, wherein each step takes place by execution of specific sets of machine codes on at least one processor configured to perform a predefined set of basic operations in response to receiving a corresponding basic instruction selected from a predefined native instruction set of codes, wherein the specific sets of machine codes are selected from the native instruction set.

3. The computer-implemented method of claim 1, further comprising:
collection of purchase data, using a customer relationship management server; and
transmission of the purchase data to a purchase data server from the customer relationship management server.

4. The computer-implemented method of claim 3, further comprising, transmission, from the purchase data server, of the purchase data to the Analytics Server, wherein the purchase data includes any one or more of: receipt amount, product identification, identification of at least one mobile device.

5. The computer-implemented method of claim 1, further comprising:
determination as to presence of a physical advertisement at the at least one mobile device's location, wherein the determination is made by detection of at least one physical beacon located at the physical advertisement;
determination as to whether the at least one mobile device is facing the advertisement, wherein the determination uses any one or more of the at least one mobile device's: accelerometer, compass, directional path, speed;
transmission, by the at least one mobile device, of data emanating from the physical beacon located at the physical advertisement;
transmission of the collected and determined data to a visit data server; and
transmission, from the visit data server, of the collected and determined data to the analytics server.

6. The computer-implemented method of claim 1, wherein collection of the at least one mobile device's location data comprises the steps of:
effecting, by execution of a software development kit resident on the at least one mobile device, any one or more of:
establishing connection between the at least one mobile device with a Visit data server;
providing the Visit data server with the at least one mobile device's location;
receiving a list of beacons from the Visit data server, wherein the list of beacons includes any one or more of: physical and virtual beacon regions, wherein the regions are defined by latitude and longitudinal coordinates;
registering the list of beacons with the operating system of the at least one mobile device;
notifying the Visit data server regarding entry of the at least one mobile device into a beacon region, when the at least one mobile device enters a region;
notifying the Visit data server upon the at least one mobile device's exit from the region; and
receipt of one of: the at least one mobile device's identification number, latitude, longitude, horizontal accuracy, Service Set Identifier (SSID) and region identification.

7. The computer-implemented method of claim 1, wherein the attribution calculation includes any one of:
calculation of a base attribution rate, wherein the base attribution rate is the percentage of how many users of the at least one mobile device: that were served the digital advertisement and were determined to have been located at an advertised location; and
calculation of lift, wherein lift calculation includes determining difference in visitation rate of users exposed to the at least one digital advertisement and users who were not exposed to the at least one digital advertisement.

8. The computer-implemented method of claim 7, wherein the base attribution rate calculation includes determining how many users purchased a product at the advertised location.

9. A non-transitory computer program product comprising a computer usable medium having control logic stored therein for causing a computer processor to perform first party data mobile attribution using multiple independent sources of computer derived data, said control logic comprising computer readable program code for:
impression monitoring, by a 1×1 pixel tag embedded within at least one digital advertisement served to at least one mobile device;
transmission, by the at least one mobile device, of the 1×1 pixel tag's impression data to an Ad Data Server, wherein the impression data includes any one or more of the following: location of the at least one mobile device, time, campaign identification of the at least one digital advertisement, identification of an entity serving the at least one digital advertisement;
transmission, from the Ad Data Server, of the collected data to an Analytics Server, wherein the collected data is any one or more of: impression data relating to the at least one digital advertisement, impression data from at least one virtual beacon, impression data from at least one physical beacon, purchase data from a purchase data server, location data of the at least one mobile device; and
conversion of the transmitted data by the Analytics Server, wherein the conversion comprises of an attribution calculation.

10. The computer program product of claim 9, further comprising computer readable program code for:
collection of purchase data, using a customer relationship management server; and
transmission of the purchase data to a purchase data server from the customer relationship management server.

11. The computer program product of claim of claim 10, further comprising computer readable program code for transmission, from the purchase data server, of the purchase data to the Analytics Server, wherein the purchase data includes any one or more of: receipt amount, product identification, identification of at least one mobile device.

12. The computer program product of claim 9, further comprising computer readable program code for:
determination as to presence of a physical advertisement at the at least one mobile device's location, wherein the determination is made by detection of at least one physical beacon located at the physical advertisement;
determination as to whether the at least one mobile device is facing the advertisement, wherein the determination uses any one or more of the at least one mobile device's: accelerometer, compass, directional path, speed;
transmission, by the at least one mobile device, of data emanating from the physical beacon located at the physical advertisement;
transmission of the collected and determined data to a visit data server; and
transmission, from the visit data server, of the collected and determined data to the analytics server.

13. The computer program product of claim 9, wherein the computer readable program code for collection of the at least one mobile device's location data comprises computer readable program code for:
effecting, by execution of a software development kit resident on the at least one mobile device, any one or more of:
establishing connection between the at least one mobile device with a Visit data server;
providing the Visit data server with the at least one mobile device's location;
receiving a list of beacons from the Visit data server, wherein the list of beacons includes any one or more of: physical and virtual beacon regions, wherein the regions are defined by latitude and longitudinal coordinates;
registering the list of beacons with the operating system of the at least one mobile device;
notifying the Visit data server regarding entry of the at least one mobile device into a beacon region, when the at least one mobile device enters a region;
notifying the Visit data server upon the at least one mobile device's exit from the region; and
receipt of one of: the at least one mobile device's identification number, latitude, longitude, horizontal accuracy, Service Set Identifier (SSID) and region identification.

14. The computer program product of claim 9, wherein the computer readable program code for attribution calculation includes computer readable program code for any one of:
calculation of a base attribution rate, wherein the base attribution rate is the percentage of how many users of the at least one mobile device: that were served the digital advertisement and were determined to have been located at an advertised location; and
calculation of lift, wherein lift calculation includes determining difference in visitation rate of users exposed to the at least one digital advertisement and users who were not exposed to the at least one digital advertisement.

15. The computer program product of claim 14, wherein the computer readable program code for base attribution rate calculation includes computer readable program code for determining how many users purchased a product at the advertised location.

16. A first party data mobile attribution system, the system comprising:
at least one mobile device;
a software development kit installed on the at least one mobile device, wherein execution of the software development kit enables interaction between the at least one mobile device and other components of the system;
a Visit data server, in communication with the at least one mobile device, wherein the Visit data server connects the at least one mobile device with the system's internal components for handling data collection and transmits relevant beacon regions to the at least one mobile device;
at least one digital advertisement, served to the at least one mobile device, wherein the at least one digital advertisement includes a 1×1 image pixel embedded within it;
an Ad Data server, in communication with the at least one mobile device, wherein the Ad Data server collects advertisement serving impressions from the at least one mobile device as sent to the Ad Data Server by execution of the 1×1 image pixel; and
an Analytics server, in communication with the Ad Data server and the Visit data server, wherein the Analytics server converts data collected from different system components.

17. The system of claim 16, further comprising at least one physical beacon, wherein the at least one beacon is in communication with the at least one mobile device and wherein the at least one beacon transmits information regarding interaction between the at least one mobile device and the at least one beacon.

18. The system of claim 16, further comprising at least one virtual beacon, wherein the at least one beacon is in communication with the at least one mobile device and wherein the at least one beacon transmits information regarding interaction between the at least one mobile device and the at least one beacon.

19. The system of claim 16, further comprising:
a customer relationship management server, in communication with the at least one mobile device; and
a purchase data server, wherein the purchase data server is in communication with the Analytics server.
